(19) United States
(12) Patent Application Publication
(10) Pub. No.: US 2012/0093119 A1
(43) Pub. Date: Apr. 19, 2012

(54) METHOD AND APPARATUS FOR TRANSMITTING SOUNDING REFERENCE SIGNAL IN WIRELESS COMMUNICATION SYSTEM

(76) Inventors: So Yeon Kim, Anyang-si (KR); Han Gyu Cho, Anyang-si (KR); Jae Hoon Chung, Anyang-si (KR); Min Seok Noh, Anyang-si (KR); Yeong Hyeon Kwon, Anyang-si (KR)

(21) Appl. No.: 13/378,961

(22) PCT Filed: Jun. 17, 2010
(86) PCT No.: PCT/KR2010/003924

§ 371 Date: Dec. 16, 2011

Related U.S. Application Data
(60) Provisional application No. 61/218,392, filed on Jun. 18, 2009.

(51) Int. Cl. H04W 72/04

(52) U.S. Cl. 370/329

(57) ABSTRACT

The present invention provides a method and an apparatus for transmitting a sounding reference signal. A terminal receives from a base station a sounding reference signal (SRS) configuration that includes a cell specific SRS configuration and a terminal specific SRS configuration, via a downlink carrier. The terminal then transmits a sounding reference signal based on the SRS configuration via an uplink carrier that is linked to the downlink carrier.

### TECHNICAL FIELD

The present invention relates to wireless communication and, more particularly, to a method and apparatus for transmitting a sounding reference signal in a wireless communication system.

### BACKGROUND ART

3rd Generation Partnership Project (3GPP) Long Term Evolution (LTE) (i.e., the improvement of a Universal Mobile Telecommunications System (UMTS)) is introduced as 3GPP release 8. 3GPP LTE uses Orthogonal Frequency Division Multiple Access (OFDMA) in downlink and uses Single Carrier-Frequency Division Multiple Access (SC-FDMA) in uplink. Multiple Input Multiple Output (MIMO) having a maximum of 4 antennas is adopted. Recently, a discussion on 3GPP LTE-Advanced (LTE-A) which is the evolution of 3GPP LTE is in progress.

Technology introduced in 3GPP LTE-A includes a carrier aggregation, a relay, etc. A 3GPP LTE system is a single carrier system that supports only one bandwidth (i.e., one component carrier) of {1.4, 3, 5, 10, 15, 20} MHz. However, LTE-A is introducing multiple carriers employing a carrier aggregation. A component carrier is defined by a center frequency and a bandwidth. A multiple carrier system uses a plurality of component carriers having a smaller bandwidth than the entire bandwidth.

A sounding reference signal (SRS) is an uplink signal that a mobile station transmits it to a base station for the uplink scheduling of the base station. The base station measures the status of an uplink channel by using the SRS. The base station assigns uplink radio resources to the mobile station on the basis of the measured uplink channel.

In the existing 3GPP LTE system, the transmission of an SRS is taken into account on the basis of a single carrier. With the introduction of multiple carriers, however, a scheme capable of transmitting an SRS has not yet been disclosed.

### DISCLOSURE

### Technical Problem

The present invention provides a method and apparatus for transmitting a sounding reference signal in a multiple carrier system.

### Technical Solution

In an aspect, a method of transmitting a sounding reference signal (SRS) in a multiple carrier system includes receiving, by a user equipment (UE), an SRS configuration including a cell-specific SRS configuration and a UE-specific SRS configuration through a downlink carrier from a base station (BS), and transmitting, by the UE, the SRS based on the SRS configuration through an uplink carrier linked to the downlink carrier.

The downlink carrier may be one of a plurality of downlink carriers assigned to the UE.

The SRS configuration may be received through all downlink carriers assigned to the UE.

The method may further include transmitting, by the UE, a first SRS through a first uplink carrier. The second uplink carrier may not be linked to the downlink carrier.

The SRS configuration may include SRS configurations for a plurality of uplink carriers.

In another aspect, a user equipment (UE) for transmitting a sounding reference signal (SRS) in a multiple carrier system includes a radio frequency (RF) unit for transmitting the SRS through an uplink carrier, and a processor coupled to the RF unit and for configuring the SRS. An SRS configuration for configuring the SRS is received from a base station (BS) through a downlink carrier, the SRS configuration includes a cell-specific SRS configuration and a UE-specific SRS configuration, and the uplink carrier is linked to the downlink carrier.

### Advantageous Effects

An SRS can be flexibly configured according to a carrier aggregation scheme. Furthermore, compatibility with the existing single carrier system can be maintained, and the complexity of UE and signaling overhead can be reduced.

### DESCRIPTION OF DRAWINGS

FIG. 1 shows the structure of a radio frame in 3GPP LTE.

FIG. 2 shows the structure of a downlink subframe in 3GPP LTE.

FIG. 3 shows an example of an uplink subframe in 3GPP LTE.

FIG. 4 shows an example of multiple carriers.

FIG. 5 shows an example of cross-carrier scheduling.

FIG. 6 shows an example of the operation of multiple carriers.

FIG. 7 shows an SRS configuration in a case 1.

FIG. 8 shows an SRS configuration in a case 2.

FIG. 9 shows an SRS configuration in a case 3.

FIG. 10 shows an SRS configuration in a case 4.

FIG. 11 shows an SRS configuration in a case 5.

FIG. 12 shows an SRS configuration in a case 6.

FIG. 13 shows an SRS configuration in a case 7.

FIG. 14 shows an SRS configuration in a case 8.

FIG. 15 shows an SRS configuration in a case 9.

FIG. 16 is a block diagram showing wireless apparatuses in which embodiments of present invention are implemented.

### MODE FOR INVENTION

A User Equipment (UE) may be fixed or mobile and also be called another terminology, such as a Mobile Station (MS), a Mobile Terminal (MT), a User Terminal (UT), a Subscriber Station (SS), a wireless device, a Personal Digital Assistant (PDA), a wireless modem, or a handheld device.

A Base Station (BS) commonly refers to a fixed station communicating with UEs, and it may be called another terminology, such as an evolved NodeB (eNB), a Base Transceiver System (BTS), or an access point.

Each BS provides communication service to a specific geographical area (commonly called a cell). The cell may be classified into a plurality of areas (called sectors).

Hereinafter, downlink (DL) means communication from a BS to UE, and uplink (UL) means communication from UE to a BS. In downlink, a transmitter may be part of a BS, and a receiver may be part of UE. In uplink, a transmitter may be part of UE, and a receiver may be part of a BS.

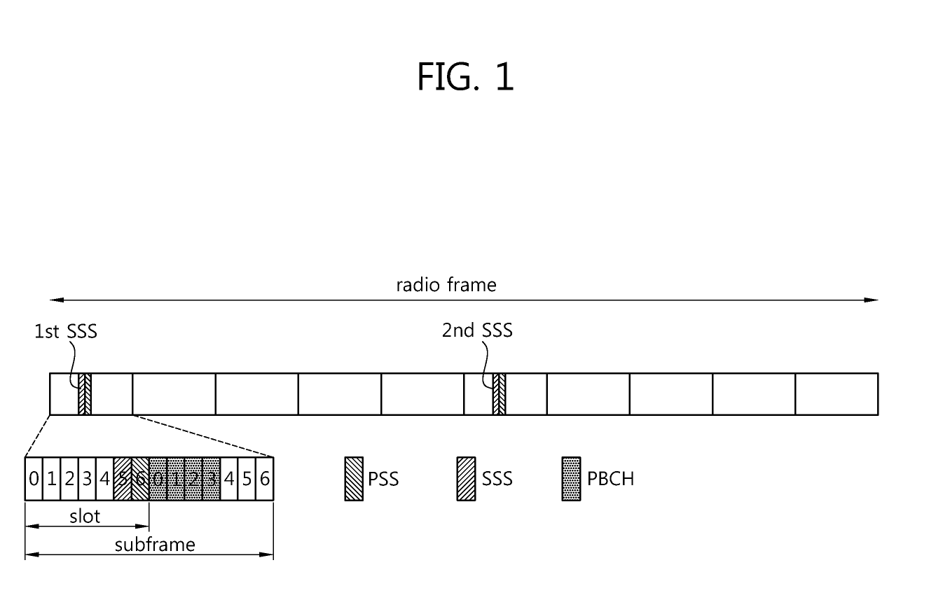

FIG. 1 is a diagram showing the structure of a radio frame in 3GPP LTE. For the structure of the radio frame, reference may be made to Paragraph 6 of 3GPP TS 36.211 V8.7.0 (2009-05) “Evolved Universal Terrestrial Radio Access (E-UTRA); Physical Channels and Modulation (Release 8)”. The radio frame includes 10 subframes to which respective indices 0 to 9 are assigned, and one subframe includes two slots. The time that one subframe is taken to be transmitted is called a Transmission Time Interval (TTI). For example, the length of one subframe may be 1 ms, and the length of one slot may be 0.5 ms.

One slot may include a plurality of Orthogonal Frequency Division Multiplexing (OFDM) symbols in the time domain. The OFDM symbol is only for representing one symbol period in the time domain because 3GPP LTE uses Orthogonal Frequency Division Multiple Access (OFDMA) in downlink and is not restricted to a multiple access method or a name. For example, the OFDM symbol may be called another name, such as a Single Carrier Frequency Division Multiple Access (SC-FDMA) symbol or a symbol period.

Although one slot has been illustrated to include 7 OFDM symbols, the number of OFDM symbols included in one slot may be changed depending on the length of a Cyclic Prefix (CP). In accordance with 3GPP TS 36.211 V8.7.0 (2009-05), one subframe includes 7 OFDM symbols in a normal CP and includes 6 OFDM symbols in an extended CP.

A Primary Synchronization Signal (PSS) is transmitted in the last OFDM symbols of a first slot (the first slot of a first subframe (a subframe having an index 0) and an eleventh slot (the first slot of a sixth subframe (a subframe having an index 5). The PSS is used to obtain OFDM symbol synchronization or slot synchronization and is associated with a physical cell identity (ID). A Primary Synchronization Code (PSC) is a sequence used in the PSS, and 3GPP LTE includes three PSCs. One of the three PSCs is transmitted as the PSS according to a cell ID. The same PSC is used in the last OFDM symbols of the first slot and the eleventh slot.

A Secondary Synchronization Signal (SSS) includes a first SSS and a second SSS. The first SSS and the second SSS are transmitted in OFDM symbols neighboring OFDM symbols in which PSSs are transmitted. The SSS is used to acquire frame synchronization. The SSS, together with the PSS, is used to acquire a cell ID. The first SSS and the second SSS use different Secondary Synchronization Codes (SSCs). Assuming that each of the first SSS and the second SSS includes 31 subcarriers, sequences of two SSCs, each having a length of 31, are used in the first SSS and the second SSS, respectively.

A Physical Broadcast Channel (PBCH) is transmitted in four former OFDM symbols of the second slot of a first subframe. The PBCH carries system information that is indispensably required for UE to communicate with a BS. System information transmitted through the PBCH is called a Master Information Block (MIB). Meanwhile, system information transmitted through a Physical Downlink Shared Channel (PDSCH) indicated by a Physical Downlink Control Channel (PDCCH) is called a System Information Block (SIB).

As disclosed in 3GPP TS 36.211 V8.7.0 (2009-05), in LTE, a physical channel may be divided into data channels, such as a Physical Downlink Shared Channel (PDSCH) and a Physical Uplink Shared Channel (PUSCH) and control channels, such as a Physical Downlink Control Channel (PDCCH), a Physical Control Format Indicator Channel (PCFICH), a Physical Hybrid-ARQ Indicator Channel (PHICH), and a Physical Uplink Control Channel (PUCCH).

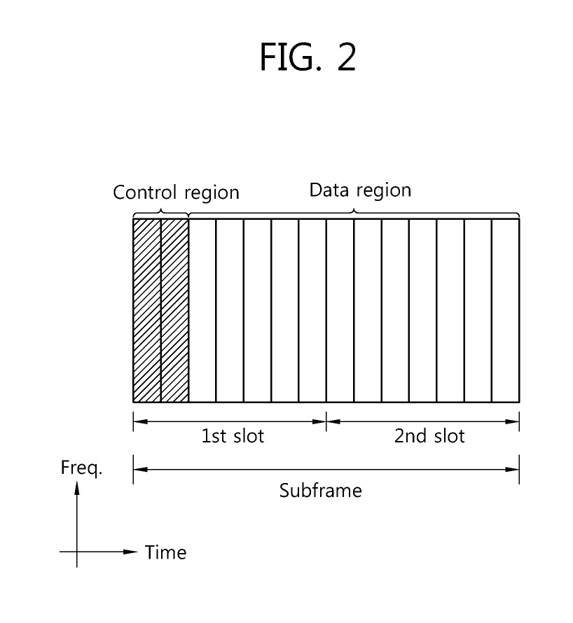

FIG. 2 shows the structure of a downlink subframe in 3GPP LTE. The subframe is divided into a control region and a data region in the time domain. The control region includes a maximum of 3 OFDM symbols in the former of a first slot within the subframe, but the number of OFDM symbols included in the control region may be changed. PDCCHs are assigned to the control region, and PDSCHs are assigned to the data region.

A Resource Block (RB) is a resource assignment unit, and it includes a plurality of subcarriers in one slot. For example, if one slot includes 7 OFDM symbols in the time domain and the RB includes 12 subcarriers in the frequency domain, one RB may include 7×12 Resource Elements (REs).

A PCFICH transmitted in the first OFDM symbol of the subframe carries a Control Format Indicator (CFI) about the number of OFDM symbols (i.e., the size of the control region) which is used to transmit control channels within the subframe. UE first receives the CFI on the PCFICH and then monitors PDCCHs.

A PHICH carries positive-acknowledgement (ACK)/negative-acknowledgement (NACK) signals for an uplink Hybrid Automatic Repeat Request (HARQ). ACK/NACK signals for uplink data transmitted by UE are transmitted on the PHICH.

Control information transmitted through a PDCCH is called Downlink Control Information (DCI). The DCI may include the resource assignment (hereinafter also referred to as a ‘downlink grant’) of a PDSCH, the resource assignment (hereinafter also referred to as an ‘UL grant’) of a PUSCH, a set of transmission power control commands for individual UEs within a specific UE group and/or the activation of a Voice over Internet Protocol (VoIP).

As described in section 9 of 3GPP TS 36.213 V8.7.0 (2009-05), blind decoding is used to detect a PDCCH. Blind decoding uses a method of checking the owner or use of a PDCCH by demasking a specific identifier in the Cyclic Redundancy Check (CRC) of a received PDCCH (hereinafter referred to as a ‘PDCCH candidate’) and checking a CRC error. UE monitors one or more PDCCHs for every subframe. Here, the monitoring means that UE attempts the decoding of the PDCCHs according to a monitored PDCCH format.

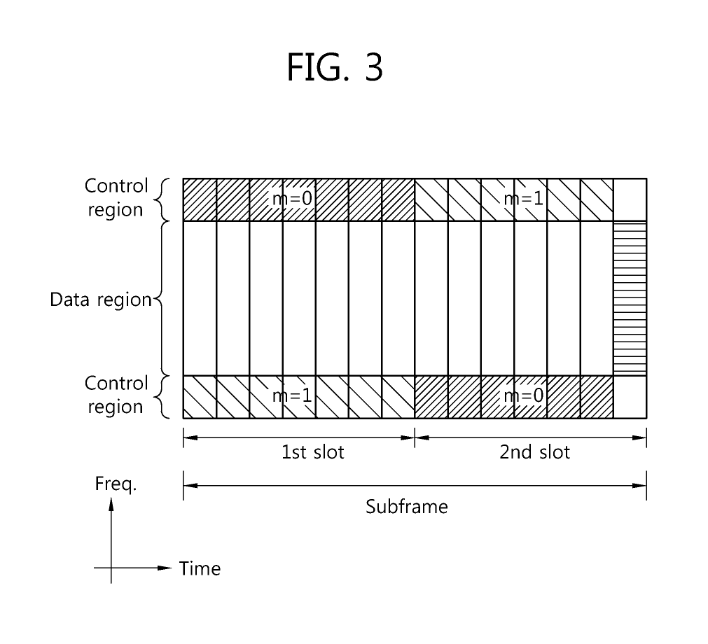

FIG. 3 shows an example of an uplink subframe in 3GPP LTE.

An uplink subframe may be divided into a control region to which a Physical Uplink Control Channel (PUCCH) carrying uplink control information is assigned and a data region to which a Physical Uplink Shared Channel (PUSCH) carrying uplink data is assigned. A PUCCH for one UE is assigned to a Resource Block (RB) pair in a subframe. RBs belonging to the RB pair occupy different subcarriers in a first slot and a second slot. m is a position index indicating the logical frequency domain position of the RB pair assigned to the PUCCH within a subframe. It can be seen that RBs having the same m value occupy different subcarriers in two slots.

A sounding reference signal (SRS) is transmitted through one OFDM symbol within a subframe. The OFDM symbol on which the SRS is transmitted is called a sounding symbol. The last OFDM symbol, from among a plurality of OFDM symbols within a subframe, is a sounding symbol, but this is only illustrative. The positions or the number of sounding symbols within the subframe may be changed in various ways.

In the frequency domain, the SRS may not be transmitted in the control region, but may be transmitted in the data region. UE may transmit the SRS over the entire frequency band within the data region or may transmit the SRS over part of a frequency band within the data region. UE may transmit the SRS periodically or aperiodically.

The SRS is transmitted in such a manner that a specific cyclic shift has been applied to a base sequence. An SRS sequence rSRS(n) may be represented as follows.

r^{SRS}(n)=r_{u,v}^{(α)}(n) Equation 1

Here, u is a PUCCH sequence-group number, and v is a base sequence number. α that is the cyclic shift of an SRS is given as below.

$$α = 2 π \frac{{n}_{SRS}^{cs}}{8} \qquad Equation 2$$

Here, n^{CS}_{SRS} is set by a higher layer for each UE, and n^{CS}_{SRS}=0, 1, 2, 3, 4, 5, 6, 7.

The SRS sequence r^{SRS}(n) is multiplied by an amplitude scaling factor β_{SRS} so that it conforms to transmit power P_{SRS}, and the SRS sequence is then mapped to a resource element (k,l) starting from rSRS(0) as follows.

$${α}_{2 k + {k}_{0} , l} = \{ \begin{matrix}{β}_{SRS} {r}^{SRS} ( k ) & k = 0 , 1 , … , {M}_{sc , b}^{RS} - 1 \\ 0 & otherwise\end{matrix} \qquad Equation 3$$

Here, k₀ is the start point of the frequency domain of the SRS, and M^{RS}_{sc,b} is the length of the SRS sequence and defined as follows.

M_{sc,b}^{RS}=m_{SRS,b}N_{sc}^{RB}/2 Equation 4

Here, N^{UL}_{sc} the number of subcarriers per RB, and m_{SRS,b} is a value dependent on an uplink bandwidth N^{UL}_{RB}.

For a detailed construction of the SRS, reference may be made to section 5.5.3 of 3GPP TS 36.211 V8.7.0 (2009-05) and section 8.2 of 3GPP TS 36.213 V8.7.0 (2009-05).

A transmission power P_{SRS}(i) of an SRS in a subframe i is defined as follows.

P_{SRS}(i)=min{P_{CMAX},P_{SRS}_{_{—}}_{OFFSET}+10 log₁₀(M_{SRS})+P_{PUSCH}(j)+α(j)PL+f(i)} Equation 5

Here, P_{CMAX} is a maximum set transmission power, P_{SRS}_{_{—}}_{OFFSET} is a parameter given by a higher layer, M_{SRS} is an SRS transmission bandwidth in the subframe i, f(j) is a current power control state for a PUSCH, and P_{PUSCH}(j) and a(j) are parameters.

Parameters for SRS transmission are set through an RRC message. As disclosed in section 6.3.2 of 3GPP TS 36.331 V8.6.0 (2009-06), ‘soundingRS-ul-config’ is given as follows.

SoundingRS-UL-ConfigCommon ::= CHOICE {

| | |
|---|---|
| release | NULL, |

| | |
|---|---|
| setup | SEQUENCE { |

```
    srs-BandwidthConfig ENUMERATED {bw0, bw1, bw2, bw3, bw4,
bw5, bw6, bw7},
    srs-SubframeConfig ENUMERATED {sc0, sc1, sc2, sc3, sc4, sc5,
sc6, sc7, sc8, sc9, sc10, sc11, sc12, sc13, sc14, sc15},
    ackNackSRS-SimultaneousTransmission BOOLEAN,
    srs-MaxUpPts ENUMERATED {true} OPTIONAL
  }
}
SoundingRS-UL-ConfigDedicated ::= CHOICE{
```

| | |
|---|---|
| release | NULL, |

| | |
|---|---|
| setup | SEQUENCE { |

```
    srs-Bandwidth ENUMERATED {bw0, bw1, bw2, bw3},
    srs-HoppingBandwidth ENUMERATED {hbw0, hbw1, hbw2, hbw3},
    freqDomainPosition INTEGER (0..23),
    duration BOOLEAN,
    srs-ConfigIndex INTEGER (0..1023),
    transmissionComb INTEGER (0..1),
    cyclicShift ENUMERATED {cs0, cs1, cs2, cs3, cs4, cs5, cs6, cs7}
```

}
}

Here, ‘SoundingRS-UL-ConfigCommon’ is cell-specific SRS configuration information including cell-specific parameters applied to UEs within a cell, and ‘SoundingRS-UL-ConfigDedicated’ is UE-specific SRS configuration information including UE-specific parameters applied to a specific UE.

‘srs-BandwidthConfiguration’ C_{SRS} is a cell-specific parameter for setting the bandwidth of an SRS. ‘srs-SubframeConfiguration’ is a cell-specific parameter indicating a set of subframes on which an SRS may be transmitted within a cell. ‘ackNackSRS-SimultaneousTransmission’ is a cell-specific parameter indicating whether an SRS can be transmitted simultaneously with HARQ ACK/NACK and/or a Scheduling Request (SR).

‘srs-Bandwidth’ B_{SRS} indicates the SRS transmission band of UE according to C_{SRS}. ‘srs-HoppingBandwidth’ bₕₒₚ indicates the size of a frequency hop. ‘frequencyDomainPosition’ n_{RRC} is a parameter for calculating a position in the frequency domain of an SRS. ‘Duration’ is a parameter indicating whether a BS requests one SRS transmission from UE or requests periodic SRS transmission from the UE. ‘srs-ConfigurationIndex’ I_{SRS} is a parameter for calculating an SRS cycle and an SRS subframe offset. ‘transmissionComb’ k_{TC} indicates whether an SRS is assigned to contiguous subcarriers or subcarriers spaced apart from one another at q(q>=1) subcarrier intervals. ‘cyclicShift’ n_{RRC} is a parameter used to calculate the cyclic shift of an SRS.

A multiple carrier system is described below.

A 3GPP LTE system supports a case where a downlink bandwidth and an uplink bandwidth are differently set, but one Component Carrier (CC) is a precondition for the case. This means that, in the state where one CC is defined for each of downlink and uplink, 3GPP LTE supports only a case where the downlink bandwidth is identical with or different from the uplink bandwidth. For example, the 3GPP LTE system may support a maximum of 20 MHz and have different uplink bandwidth and downlink bandwidth, but supports only one CC in each of uplink and downlink.

A spectrum aggregation (also called a bandwidth aggregation or a carrier aggregation) supports a plurality of CCs. The spectrum aggregation is introduced in order to support an increased throughput, prevent an increase of costs due to the introduction of a broadband Radio Frequency (RF), and guarantee compatibility with the existing system. For example, if 5 CCs are assigned as the granularity of a carrier unit having a 20 MHz bandwidth, a maximum bandwidth of 100 MHz can be supported.

CCs may have different sizes (i.e., bandwidths). For example, assuming that 5 CCs are used to configure a 70 MHz bandwidth, the 70 MHz bandwidth may be configured using a 5 MHz carrier (CC #0)+a 20 MHz carrier (CC #1)+a 20 MHz carrier (CC #2)+a 20 MHz carrier (CC #3)+a 5 MHz carrier (CC #4).

A case where the number of downlink CCs and the number of uplink CCs are identical with each other or a downlink bandwidth and an uplink bandwidth are identical with each other is called a symmetric aggregation. A case where the number of downlink CCs and the number of uplink CCs are different from each other or a downlink bandwidth and a uplink bandwidth are different from each other is called an asymmetric aggregation.

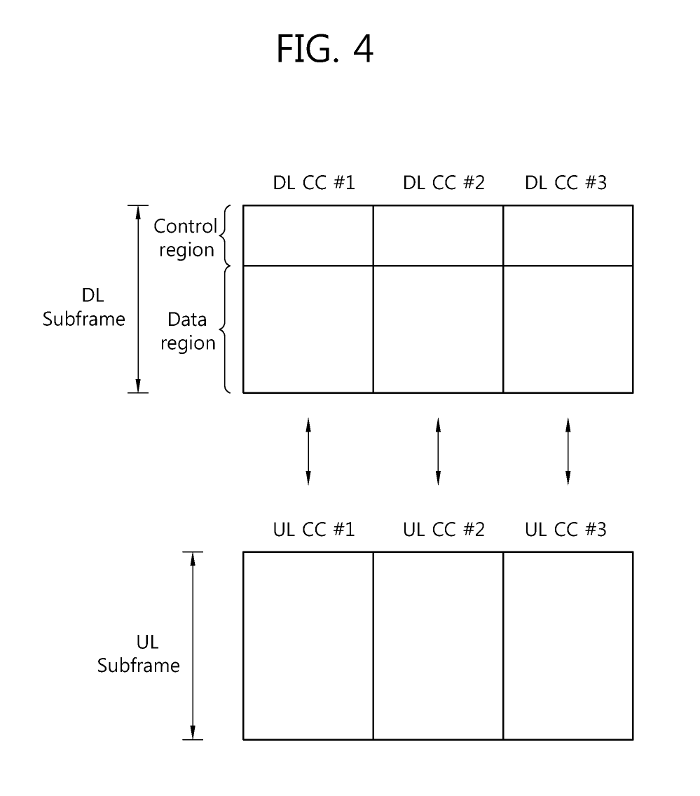

FIG. 4 shows an example of multiple carriers. Three DL CCs and UL CCs are illustrated, but the number of DL CCs and the number of UL CCs are not limited. A PDCCH and a PDSCH are independently transmitted in each DL CC, and a PUCCH and a PUSCH are independently transmitted in each UL CC.

In a multiple carrier system, a linkage between a DL CC and a UL CC may be defined. The linkage may be configured based on E-UTRA Absolute Radio Frequency Channel Number (EARFCN) information included in downlink system information and may be configured using a fixed DL/UL Tx/Rx separation relationship. The linkage refers to a mapping relationship between a DL CC through which a PDCCH carrying an UL grant is transmitted and a UL CC using the UL grant. Alternatively, the linkage may refer to a mapping relationship between a DL CC (or a UL CC) on which data for an HARQ is transmitted and a UL CC (or a DL CC) on which HARQ ACK/NACK signals are transmitted. A BS may inform UE of the linkage information as a higher layer message, such as an RRC message, or part of system information. The linkage between a DL CC and a UL CC may be fixed, but may be changed between cells/UEs.

In a multiple carrier system, CC scheduling includes two kinds of methods.

In the first method, a PDCCH-PDSCH pair is transmitted in one CC. This CC is called a self-scheduling CC. Furthermore, it means that a UL CC on which a PUSCH is transmitted becomes a CC linked to a DL CC on which a relevant PDCCH is transmitted. That is, PDSCH resources are assigned to the PDCCH on the same CC or PUSCH resources are assigned to the PDCCH on a linked UL CC.

In the second method, a DL CC on which a PDSCH is transmitted or a UL CC on which a PUSCH is transmitted is determined irrespective of a DL CC on which a PDCCH is transmitted. That is, the PDCCH and the PDSCH are transmitted on different DL CCs, or the PUSCH is transmitted on a UL CC not linked to the DL CC on which the PDCCH has been transmitted. This is called cross-carrier scheduling. The CC on which the PDCCH is transmitted is called a PDCCH carrier, a monitoring carrier, or a scheduling carrier, and the CCs on which the PDSCH/PUSCH are transmitted are called PDSCH/PUSCH carriers or scheduled carriers.

The cross-carrier scheduling may be activated or deactivated for every UE. UE having the cross-carrier scheduling activated may receive DCI including a CIF. The UE may know that a PDCCH received from the CIF included in the DCI is control information about what scheduled CC.

A DL-UL linkage predefined by the cross-carrier scheduling may be overridden. In other words, the cross-carrier scheduling may be used to schedule another CC not a linked CC irrespective of the DL-UL linkage.

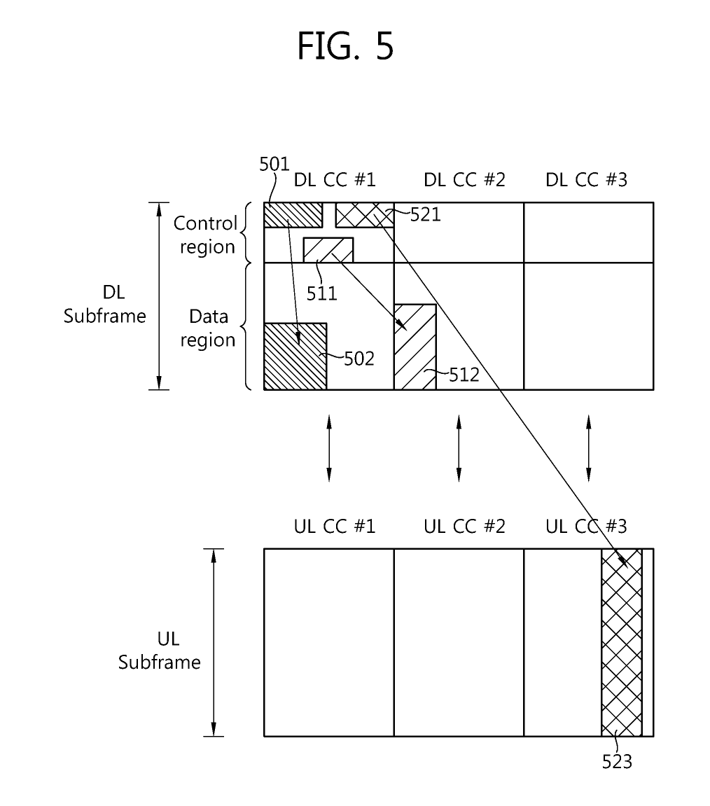

FIG. 5 shows an example of the cross-carrier scheduling. It is assumed that a DL CC #1 and a UL CC #1 are linked together, a DL CC #2 and a UL CC #2 are linked together, and a DL CC #3 and a UL CC #3 are linked together.

The first PDCCH 501 of the DL CC #1 carries DCI for the PDSCH 502 of the same DL CC #1. The second PDCCH 511 of the DL CC #1 carries DCI for the PDSCH 512 of the DL CC #2. The third PDCCH 521 of the DL CC #1 carries DCI for the PUSCH 522 of the UL CC #3 not linked to the DL CC #1.

For the cross-carrier scheduling, the DCI of a PDCCH may include a Carrier Indicator Field (CIF). The CIF indicates a DL CC or a UL CC that is scheduled based on the DCI. For example, the second PDCCH 511 may include a CIF indicating the DL CC #2. The third PDCCH 521 may include a CIF indicating the UL CC #3.

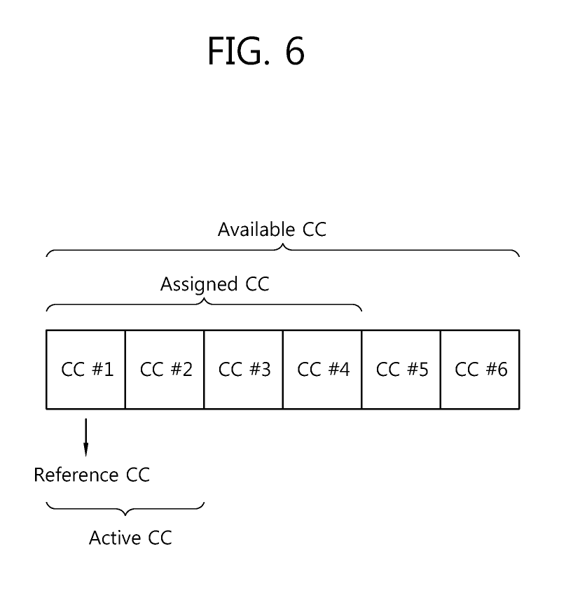

FIG. 6 shows an example of the operation of multiple carriers. Although a multiple carrier system supports a plurality of CCs, the number of supported CCs may differ depending on cell or UE capability.

Available CCs refer to all the CCs that may be used by a system (or BS). Here, there are 6 CCs from a CC #1 to a CC #6.

Assigned CCs are CCs assigned to UE by a BS according to the capability of the UE, from among available CCs. The CC #1 to the CC #4 are illustrated to be assigned CCs, but the number of assigned CCs may be smaller than or equal to the number of available CCs.

Active CCs are CCs used by UE in order to receive and/or transmit control signals and/or data to/from a BS. UE may perform the monitoring of a PDCCH and/or the buffering of a PDSCH for only active CCs. An active CC is activated or deactivated, from among assigned CCs. A CC which is always activated and on which important control information is transmitted, from among the active CCs, is called a reference CC or a primary CC.

In a multiple carrier system, a carrier configuration may be supported in a cell-specific way. Furthermore, CCs may be assigned symmetrically or asymmetrically in a UE-specific way depending on the capability of UE that supports multiple carriers.

Basically, UE sets up an RRC connection with a BS by performing an initial access process on the basis of a single CC. The BS may assign CCs to each UE through an RRC message. Thereafter, the assignment of CCs to the UE may be performed by taking various aspects, such as carrier aggregation capability, a traffic load, a load of UEs within a cell, and UE geometry, into consideration through an RRC message or L1/L2 signaling.

Even in a multiple carrier system, an SRS configuration is necessary for the scheduling of each UL CC.

In the existing LTE system, the SRS configuration is performed by a combination of two kinds of pieces of information of cell-specific SRS configuration information and UE-specific SRS configuration information. For an SRS for one UL CC, both the cell-specific SRS configuration information and the UE-specific SRS configuration information are transmitted on one DL CC.

If this single CC-based SRS configuration is applied to a multiple carrier system without change, however, it may be inefficient.

Hereinafter, a cell-specific CC refers to a CC which is an available CC and may be allocated in the entire frequency band by a BS. The UE-specific CC may become an assigned CC or an active CC.

Table below shows problems when the SRS configuration of the existing 3GPP LTE is applied to multiple carriers.

TABLE 1

| Case | Cell-Specific | UE-Specific | Problem |
|---|---|---|---|
| 1 | Symmetric | Symmetric | An SRS configuration is possible according to the |
| | | | same method as that of the existing 3GPP LTE. |
| 2 | | DL heavy | Cell-specific SRS configuration information may |
| | | | be received on a plurality of DL CCs, but the |
| | | | number of UL CCs on which an SRS can be |
| | | | transmitted using an SRS configuration is 1. |
| 3 | | UL heavy | SRS configuration information that may be |
| | | | received through one DL CC is related to an SRS in |
| | | | a UL CC linked to a relevant DL, and an SRS |
| | | | configuration for the remaining UL CCs is also |
| | | | necessary. |
| 4 | DL heavy | Symmetric | If all n DL CCs are accessible, an SRS |
| | | | configuration for UL CCs linked through respective |
| | | | DL CCs may be transmitted. |
| 5 | | DL heavy | Since the number of DL CCs n owned by a cell and |
| | | | the number of DL CCs n owned by UE may differ, |
| | | | an SRS configuration for the same UL CC has to be |
| | | | transmitted through all the DL CCs. |
| 6 | | UL heavy | Since the DL/UL CC linkage of UE may be set up |
| | | | differently from the DL/UL linkage of a cell, an |
| | | | SRS configuration according to the DL/UL linkage |
| | | | of the cell may not be valid for the UE, and there is |
| | | | also the problem of 3). |
| 7 | UL heavy | Symmetric | An independent SRS configuration cannot be |
| | | | defined for n UL CCs paired with one DL CC. |
| 8 | | DL heavy | Since the DL/UL CC linkage of UE may be set up |
| | | | differently from the DL/UL linkage of a cell, an |
| | | | SRS configuration according to the DL/UL linkage |
| | | | of the cell may not be valid for the UE. |
| 9 | | UL heavy | Since the number of DL CCs n owned by a cell and |
| | | | the number of DL CCs n owned by UE may differ, |
| | | | an independent SRS configuration cannot be |
| | | | defined for n UL CCs paired with one DL CC. |

In Table above, ‘DL heavy’ is a relationship of DL CC: UL CC=n:1, and it means that DL CCs larger than UL CCs may be assigned. ‘UL heavy’ is a relationship of DL CC: UL CC=1:n, and it means that UL CCs larger than DL CCs may be assigned. In the case 2, what ‘Cell-specific’ is symmetric and ‘UE-specific’ is DL heavy means that the number of cell-specific DL CCs and the number of cell-specific UL CCs are identical with each other, but UE-specific DL CCs larger than UE-specific UL CCs are assigned owing to the capability of UE, traffic, a load, etc.

An SRS configuration for each of the cases is hereinafter proposed. In the following embodiments, the number of cell-specific DL CCs, the number of cell-specific UL CCs, the UE-specific DL CCs, and the number of UE-specific UL CCs are only illustrative.

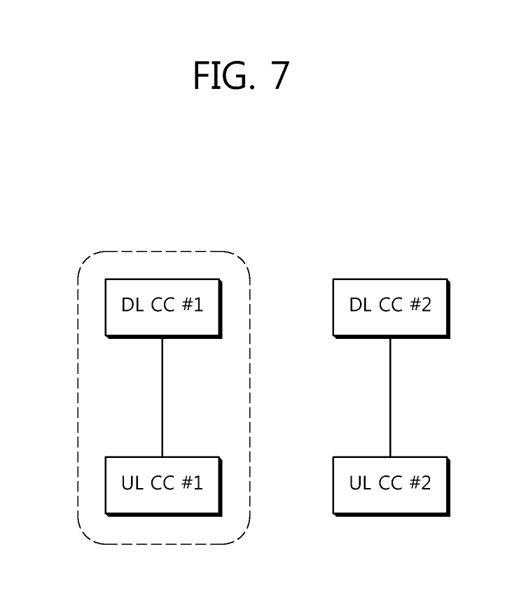

FIG. 7 shows an SRS configuration in the case 1 and shows an example where both cell-specific CCs and UE-specific CCs are assigned symmetrically.

Cell-specific DL CCs include a DL CC #1 and a DL CC #2, and cell-specific UL CCs include a UL CC #1 and a UL CC #2. The DL CC #1 is linked to the UL CC #1, and the DL CC #2 is linked to the UL CC #2. The DL/UL CCs are mapped in a 1:1 way. The DL CC #1 and the UL CC #1 are assigned to UE.

For an SRS configuration for each of the UL CCs, a BS may transmit SRS configuration information to the UE through the linked DL CC. The UE may transmit an SRS for the UL CC #1 on the basis of cell-specific SRS configuration information and UE-specific SRS configuration information which are transmitted through the DL CC #1.

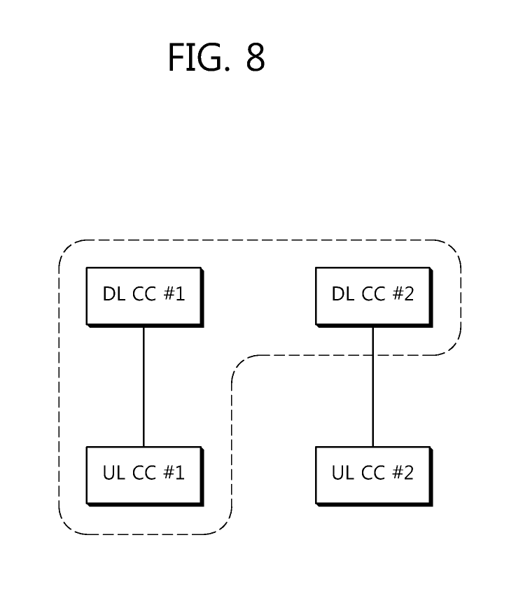

FIG. 8 shows an SRS configuration in the case 2 and shows an example where cell-specific CCs are symmetric, but UE-specific CCs are assigned according to DL heavy.

A DL CC #1, a DL CC #2, and a UL CC #1 are assigned to UE. The UE may receive an SRS configuration through the two DL CCs (i.e., the DL CC #1 and the DL CC #2), respectively, but the number of UL CCs on which an SRS will be transmitted is 1 (i.e., the UL CC #1). Accordingly, there is a need for a process in which the UE limits a DL CC on which an SRS configuration for one UL CC has been received or the UE determines valid information from the SRS configuration received from all the DL CCs assigned thereto.

Cell-specific SRS information may be transmitted through all the DL CCs. UE may determine cell-specific SRS information, transmitted through a DL CC (e.g., the DL CC #1) linked to an UL CC assigned thereto, as valid cell-specific SRS information.

UE-specific SRS information may be transmitted through a DL CC linked to a UL CC assigned to UE, on the basis of Tx/Rx separation information of SIB2. Alternatively, the UE-specific SRS information may be transmitted through a reference DL CC.

UE-specific SRS information may be transmitted through at least one of DL CCs assigned to UE. For example, the UE-specific SRS information may be transmitted through both the DL CC #1 and the DL CC #2 assigned to UE. The UE may know that the UE-specific SRS information is UE-specific SRS information about the UL CC #1 although the UE-specific SRS information is received through the DL CC #2.

UE-specific SRS information may be transmitted through all the DL CCs.

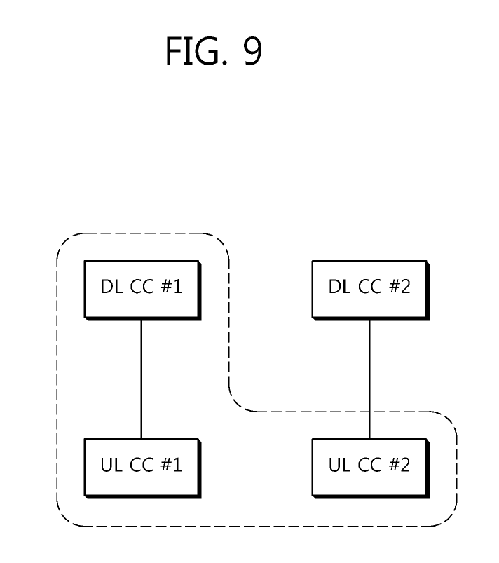

FIG. 9 shows an SRS configuration in the case 3 and shows an example where cell-specific CCs are symmetric, but UE-specific CCs are assigned according to UL heavy. A DL CC #1, a UL CC #1, and a UL CC #2 are assigned to UE.

The UE may receive an SRS configuration in one DL CC #1, but may configure only an SRS for one CC using one SRS configuration according to conventional 3GPP LTE. An SRS configuration for the UL CC #1 linked to the DL CC #1 may be transmitted through the DL CC #1. In this case, however, there is a problem in that an SRS configuration for the other UL CC #2 is impossible.

A cell-specific SRS configuration for all the UL CCs may be transmitted through one DL CC. A CC indicator indicating that cell-specific SRS configuration information is about what UL CC may be included in the cell-specific SRS configuration information.

Cell-specific SRS configuration information transmitted through a DL CC may be in common applied to all the UL CCs.

Cell-specific SRS configuration information transmitted through a DL CC may be used in a cell-specific SRS configuration for a linked UL CC, and a cell-specific SRS configuration for the remaining UL CCs may be predefined without signaling. For example, the cell-specific SRS configuration for the remaining UL CCs has an offset predefined from the cell-specific SRS configuration information transmitted through the DL CC. The offset may include a time offset, a frequency offset, a cyclic shift pattern, etc. Alternatively, the cell-specific SRS configuration may be predefined on the basis of information (e.g., a UL CC index or a cell ID) specific to the remaining UL CCs.

Cell-specific SRS configuration information transmitted through a DL CC may be used in a cell-specific SRS configuration for a linked UL CC, and an offset may be additionally transmitted for a cell-specific SRS configuration for the remaining UL CCs. The offset may be included in the cell-specific SRS configuration information or may be transmitted through an additional message. The offset may include a time offset, a frequency offset, a cyclic shift pattern, etc.

A UE-specific SRS configuration for all the UL CCs may be transmitted through one DL CC. A CC indicator indicating that UE-specific SRS configuration information is about what UL CC may be included in UE-specific SRS configuration information.

UE-specific SRS configuration information transmitted through a DL CC may be in common applied to all the UL CCs.

The UE-specific SRS configuration information transmitted through the DL CC may be used in a UE-specific SRS configuration for a linked UL CC, and a UE-specific SRS configuration for the remaining UL CCs may be predefined without signaling. For example, the UE-specific SRS configuration of the remaining UL CCs has an offset predefined from the UE-specific SRS configuration information transmitted through the DL CC. The offset may include a time offset, a frequency offset, a cyclic shift pattern, etc. Alternatively, the cell-specific SRS configuration may be predefined on the basis of information (e.g., a UL CC index or a cell ID) specific to the remaining UL CCs.

The UE-specific SRS configuration information transmitted through the DL CC may be used in a cell-specific SRS configuration for a linked UL CC, and an offset may be additionally transmitted for the UE-specific SRS configuration of the remaining UL CCs. The offset may be included in the UE-specific SRS configuration information or may be transmitted through an additional message.

Cell-specific SRS configuration information may be transmitted in each DL CC, and a UE-specific SRS configuration for a UL CC further required according to the capability of UE may be transmitted through UE-specific RRC signaling. For example, cell-specific SRS configuration information about the UL CC #2 is received through the DL CC #1 and shared by the UL CC #1. UE-specific SRS configuration information about the UL CC #2 is received through an additional UE-specific RRC message.

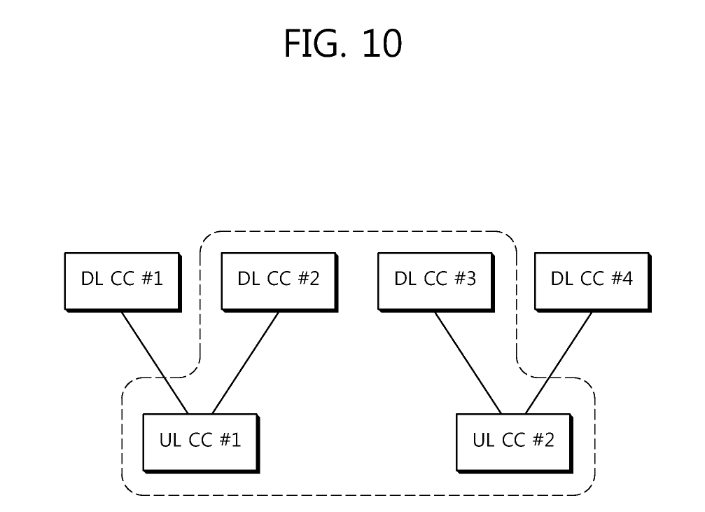

FIG. 10 shows an SRS configuration in the case 4 and shows an example where cell-specific CCs are assigned according to DL heavy, but UE-specific CCs are symmetrically assigned. Cell-specific DL CCs include DL CCs #1, #2, #3, and #4, and cell-specific UL CCs include a UL CC #1 and a UL CC #2. The DL CCs #1 and #2 are linked to the UL CC #1, and the DL CCs #3 and #4 are linked to the UL CC #2. The DL CCs #1 and #2 and the UL CCs #1 and #2 are assigned to UE.

For an SRS configuration for each UL CC, a BS may transmit SRS configuration information to the UE through the linked DL CC. The UE may transmit an SRS for the UL CC #1 on the basis of cell-specific SRS configuration information and UE-specific SRS configuration information which are transmitted through the DL CC #2. Furthermore, the UE may transmit an SRS for the UL CC #2 on the basis of cell-specific SRS configuration information and UE-specific SRS configuration information which are transmitted through the DL CC #3.

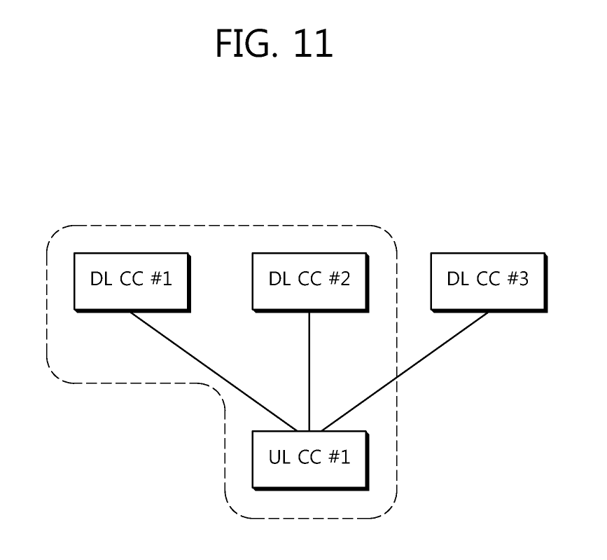

FIG. 11 shows an SRS configuration in the case 5 and shows an example where cell-specific CCs and UE-specific CCs are assigned according to DL heavy. A DL CC #1, a DL CC #2, and a UL CC #1 are assigned to UE.

An SRS configuration for the UL CC #1 may be transmitted through the DL CCs #1 and #2. It is necessary to support UEs using only a single carrier.

The UE-specific SRS configuration information may be received through the DL CC #1 or the DL CC #2 linked to the UL CC #1 assigned to the UE. Alternatively, a restriction may be placed so that an SRS configuration is received through a reference DL CC in order to prevent RRC signaling from being redundantly transmitted to another UE.

Alternatively, the UE-specific SRS configuration information may also be transmitted through any one of the DL CCs assigned to the UE, but an indicator designating an UL CC in which the UE-specific SRS configuration information is used may be included in the UE-specific SRS configuration information.

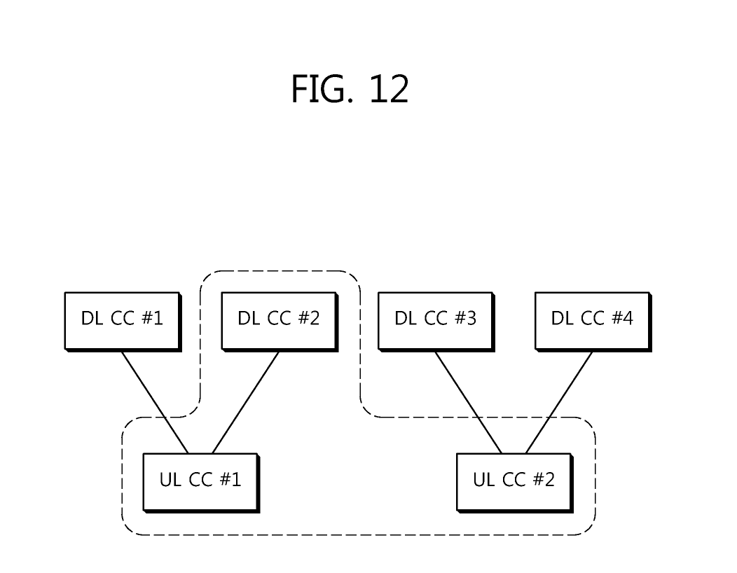

FIG. 12 shows an SRS configuration in the case 6 and shows an example where cell-specific CCs are assigned according to DL heavy, but UE-specific CCs are assigned according to UL heavy. A DL CC #1, a UL CC #1, and a UL CC #2 are assigned to UE.

The UE may receive an SRS configuration in the one DL CC #1, but may set only an SRS for one CC as one SRS configuration according to conventional 3GPP LTE. An SRS configuration for the UL CC #1 linked to the DL CC #1 may be transmitted through the DL CC #1. In this case, however, there is a problem in that an SRS configuration for the remaining UL CC #2 is impossible.

A cell-specific SRS configuration for all the UL CCs may be transmitted through one DL CC. A CC indicator indicating that cell-specific SRS configuration information is about what UL CC may be included in the cell-specific SRS configuration information.

The cell-specific SRS configuration information transmitted through the DL CC may be in common applied to all the UL CCs.

The cell-specific SRS configuration information transmitted through the DL CC may be used in a cell-specific SRS configuration for a linked UL CC, and the cell-specific SRS configuration of the remaining UL CCs may be predefined without signaling. For example, the cell-specific SRS configuration of the remaining UL CCs has an offset predetermined based on the cell-specific SRS configuration information transmitted through the DL CC. The offset may include a time offset, a frequency offset, a cyclic shift pattern, etc. Alternatively, a cell-specific SRS configuration may be predefined on the basis of information (e.g., a UL CC index or a cell ID) specific to the remaining UL CCs.

The cell-specific SRS configuration information transmitted through the DL CC may be used in a cell-specific SRS configuration for a linked UL CC, and an offset may be additionally transmitted for the cell-specific SRS configuration of the remaining UL CCs. The offset may be included in the cell-specific SRS configuration information or may be transmitted through an additional message. The offset may include a time offset, a frequency offset, a cyclic shift pattern, etc.

A UE-specific SRS configuration for all the UL CCs may be transmitted through one DL CC. A CC indicator, indicating that UE-specific SRS configuration information is about what UL CC, may be included in the UE-specific SRS configuration information.

The UE-specific SRS configuration information transmitted through the DL CC may be in common applied to all the UL CCs.

The UE-specific SRS configuration information transmitted through the DL CC may be used in a UE-specific SRS configuration for a linked UL CC, and the UE-specific SRS configuration of the remaining UL CCs may be predefined without signaling. For example, the UE-specific SRS configuration of the remaining UL CCs has an offset predefined from the UE-specific SRS configuration information transmitted through the DL CC. The offset may include a time offset, a frequency offset, a cyclic shift pattern, etc. Alternatively, the UE-specific SRS configuration may be predefined on the basis of information (e.g., a UL CC index or a cell ID) specific to the remaining UL CCs.

The UE-specific SRS configuration information transmitted through the DL CC may be used in a UE-specific SRS configuration for a linked UL CC, and an offset may be additionally transmitted for the UE-specific SRS configuration of the remaining UL CCs. The offset may be included in the UE-specific SRS configuration information or may be transmitted through an additional message.

Cell-specific SRS configuration information may be transmitted in each DL CC, and UE-specific SRS configuration about a UL CC which is further necessary according to the capability of UE may be transmitted through UE-specific RRC signaling. For example, cell-specific SRS configuration information about the UL CC #2 is received through the DL CC #1 and shared by the UL CC #1. UE-specific SRS configuration information about the UL CC #2 is received through an additional UE-specific RRC message.

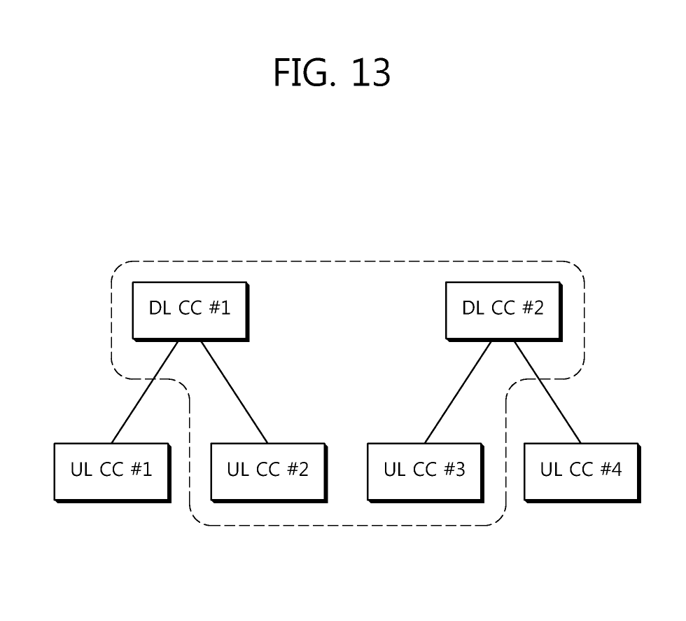

FIG. 13 shows an SRS configuration in the case 7 and shows an example where cell-specific CCs are assigned according to UL heavy, but UE-specific CCs are symmetrically assigned. Cell-specific DL CCs includes DL CCs #1 and #2, and cell-specific UL CCs include UL CCs #1, #2, #3, and #4. The DL CC #1 is linked to the UL CCs #1 and #2, and the DL CC #2 is linked to the UL CCs #3 and #4. The DL CCs #1 and #2 and the UL CCs #2 and #3 are assigned to UE.

One DL CC may be linked to a plurality of UL CCs. Since CCs are symmetrically assigned to UE, a DL CC and a UL CC are mapped to each other in a 1:1 way in a DL-UL linkage. Accordingly, an SRS configuration transmitted through a DL CC may be basically used for SRS transmission in a relevant UL CC.

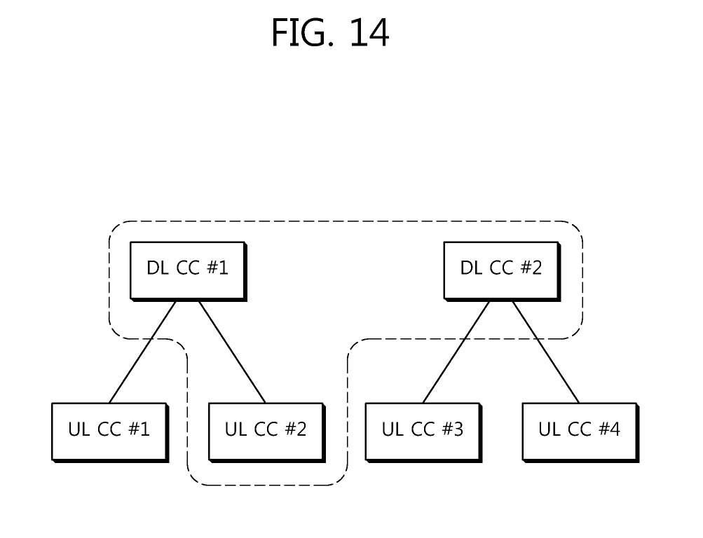

FIG. 14 shows an SRS configuration in the case 8 and shows an example where cell-specific CCs are assigned according to UL heavy, but UE-specific CCs are assigned according to DL heavy. A DL CC #1, a DL CC #2, and a UL CC #2 are assigned to UE.

An SRS configuration may be transmitted through the DL CC #1 linked to the UL CC #2.

Apart from the SRS configuration, in order to support an independent SRS configuration for a plurality of UL CCs linked to one DL CC, cell-specific SRS configuration information about the plurality of UL CCs for the one DL CC may be transmitted. The cell-specific SRS configuration information may include an identifier for distinguishing the UL CCs from each other.

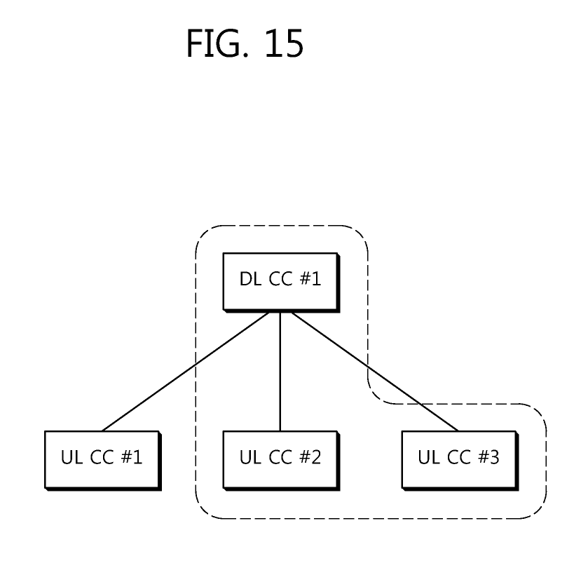

FIG. 15 shows an SRS configuration in the case 9 and shows an example where both cell-specific CCs and UE-specific CCs are assigned according to DL heavy. A DL CC #1, a UL CC #2, and a UL CC #3 are assigned to UE.

The number of UL CCs linked to the cell-specific DL CC may be different from the number of UL CCs linked to the UE-specific CC. Accordingly, an independent SRS configuration for a plurality of n UL CCs linked to one DL CC may not be defined. For example, if an SRS configuration defined through a DL CC #0 is identically used in the UL CCs #1, #2, and #3, a problem may occur from a viewpoint of a Peak-to-Average Power Ratio (PAPR).

In order to support an independent SRS configuration for a plurality of UL CCs linked to one DL CC, an SRS configuration for all the plurality of linked UL CCs may be transmitted through the one DL CC. The SRS configuration may include an identifier for distinguishing the UL CCs from each other.

Cell-specific SRS configuration information transmitted through a DL CC may be in common applied to all the UL CCs.

The cell-specific SRS configuration information transmitted through the DL CC may be used in a cell-specific SRS configuration for a linked UL CC, and a cell-specific SRS configuration for the remaining UL CCs may be predefined without signaling. For example, the cell-specific SRS configuration of the remaining UL CCs has an offset predefined from the cell-specific SRS configuration information transmitted through the DL CC. The offset may include a time offset, a frequency offset, a cyclic shift pattern, etc. Alternatively, the cell-specific SRS configuration may be predefined on the basis of information (e.g., a UL CC index or a cell ID) specific to the remaining UL CCs.

The cell-specific SRS configuration information transmitted through the DL CC may be used in a cell-specific SRS configuration for a linked UL CC, and an offset may be additionally transmitted for the cell-specific SRS configuration of the remaining UL CCs. The offset may be included in the cell-specific SRS configuration information or may be transmitted through an additional message. The offset may include a time offset, a frequency offset, a cyclic shift pattern, etc.

A UE-specific SRS configuration for all the UL CCs may be transmitted through one DL CC. UE-specific SRS configuration information may include a CC indicator indicating that the UE-specific SRS configuration information is about what UL CC.

The UE-specific SRS configuration information transmitted through the DL CC may be in common applied to all the UL CCs.

The UE-specific SRS configuration information transmitted through the DL CC may be used in a UE-specific SRS configuration for a linked UL CC, and the UE-specific SRS configuration of the remaining UL CCs may be predefined without signaling. For example, the UE-specific SRS configuration of the remaining UL CCs transmitted through the DL CC has an offset predefined from the UE-specific SRS configuration information. The offset may include a time offset, a frequency offset, a cyclic shift pattern, etc. Alternatively, the UE-specific SRS configuration may be predefined on the basis of information (e.g., a UL CC index or a cell ID) specific to the remaining UL CCs.

The UE-specific SRS configuration information transmitted through the DL CC may be used in a UE-specific SRS configuration for a linked UL CC, and an offset may be additionally transmitted for the UE-specific SRS configuration of the remaining UL CCs. The offset may be included in the UE-specific SRS configuration information or may be transmitted through an additional message.

The problems and the solutions have been proposed above for every case, but the methods may be implemented independently or in combination for an SRS configuration in a multiple carrier system.

A cell-specific RRC message through which cell-specific SRS configuration information is transmitted may be transmitted through all the DL CCs. Cell-specific SRS configuration information transmitted in each DL CC may be identical irrespective of a CC or may differ for every CC.

If a DL/UL linkage within a cell is 1:n (i.e., UL heavy), a cell-specific SRS configuration for a plurality of UL CCs may be transmitted through one DL CC. The cell-specific SRS configuration may include an identifier or an indicator for identifying the UL CCs.

UE-specific SRS configuration information may be transmitted through each DL CC.

The UE-specific SRS configuration information may be transmitted through a DL CC linked to a relevant UL CC.

The UE-specific SRS configuration information transmitted through the DL CC may include an indicator to indicate a UL CC to which an SRS configuration is applied.

A cell-specific SRS configuration for a UL CC linked to one DL CC may be transmitted according to the same method as the existing method, and a cell-specific SRS configuration for the remaining UL CCs may be included in UE-specific SRS configuration information. Alternatively, the cell-specific SRS configuration transmitted through one DL CC may be applied to all the UL CCs.

The cell-specific SRS configuration for the remaining UL CCs other than the UL CC linked to the DL CC through which cell-specific configuration information is transmitted may be predefined.

The cell-specific SRS configuration information transmitted through the DL CC may be used in a cell-specific SRS configuration for a linked UL CC, and an offset may be additionally transmitted for the cell-specific SRS configuration of the remaining UL CCs. The offset may be included in the cell-specific SRS configuration information or may be transmitted through an additional message. The offset may include a time offset, a frequency offset, a cyclic shift pattern, etc. Alternatively, a cell-specific SRS configuration may be predefined on the basis of information (e.g., a UL CC index or a cell ID) specific to the remaining UL CCs.

A UE-specific SRS configuration for a UL CC linked to one DL CC may be transmitted according to the same method as the existing method, and a UE-specific SRS configuration for the remaining UL CCs may be included in UE-specific SRS configuration information. Alternatively, a UE-specific SRS configuration transmitted through a DL CC may be applied to all the UL CCs.

The UE-specific SRS configuration of the remaining UL CCs other than a UL CC linked to a DL CC through which UE-specific configuration information is transmitted may be predefined.

The UE-specific SRS configuration information transmitted through the DL CC may be used in a UE-specific SRS configuration for a linked UL CC, and an offset may be additionally transmitted for the UE-specific SRS configuration of the remaining UL CCs. The offset may be included in the UE-specific SRS configuration information or may be transmitted through an additional message. The offset may include a time offset, a frequency offset, a cyclic shift pattern, etc. Alternatively, the UE-specific SRS configuration may be predefined on the basis of information (e.g., the UL CC index or a cell ID) specific to the remaining UL CCs.

UE may determine an SRS configuration for the remaining CCs, other than a UL CC linked to a DL CC through which an SRS configuration is received, on the basis of each UL CC index. That is, parameters included in the existing cell-specific SRS configuration information and the existing UE-specific SRS configuration information may be changed and configured so that they are dependent on a UL CC index.

Meanwhile, when SRS transmission and various carrier aggregation situations are taken into consideration, a UE-specific DL/UL linkage may be set up on the basis of a cell-specific DL/UL linkage in order to reduce the complexity of an operation and signaling overhead. For example, the cell-specific DL/UL linkage is as follows. (a DL CC #1—a UL CC #1), (a DL CC #2—a UL CC #2), (a DL CC #3—a UL CC #3), (a DL CC #4—a UL CC #4). Here, if UE supporting two DL CCs and two UL CCs uses (the DL CC #1—the UL CC #1), (the DL CC #1—the UL CC #1) as a UE-specific DL/UL linkage, signaling overhead can be reduced. However, of (the DL CC #1—the UL CC #1), (the DL CC #3—the UL CC #2) are used as the UE-specific DL/UL linkage, there is a disadvantage. This case corresponds to the case 1, but there is a problem in that the UE may not receive an SRS configuration for the UL CC #2 transmitted through the DL CC #2.

The allocation of a UE-specific CC initially configured for UE may be changed. From this point of view, the above methods may be applied in various ways as follows.

(1) If a symmetrical configuration is changed into a DL heavy configuration: It corresponds to a case where only one UL CC is used, and thus an SRS configuration may be received through a DL CC linked to the relevant UL CC.

(2) If a symmetrical configuration has been changed into a UL heavy configuration: The SRS configuration method proposed in the above UL heavy may be applied.

(3) If a DL heavy configuration has been changed into a symmetrical configuration: An SRS configuration may be received through a DL CC linked to a UL CC.

(4) If a DL heavy configuration has been changed into a UL heavy configuration: the SRS configuration method proposed in the above UL heavy may be applied.

(5) If a UL heavy configuration has been changed into a symmetrical configuration: An SRS configuration may be received through a DL CC linked to a UL CC.

(6) If a UL heavy configuration has been changed into a DL heavy configuration: An SRS configuration may be received through a DL CC linked to a UL CC.

(7) If a symmetrical configuration, a UL heavy configuration, and a UL heavy configuration remain intact, but the number of CCs or a CC frequency has been changed: An SRS configuration may be received through a DL CC linked to a UL CC.

The proposed embodiments may be applied to the transmission of UE-specific information and cell-specific information for configuring other uplink control channels, an uplink data channel, a physical signal and/or an uplink reference signal, in addition to the SRS configuration. For example, the proposed embodiments may be applied to configure PUCCH structures related to a PUCCH format 1 a PUCCH format 2, a cyclic shift, a resource size, the selection of a base sequence, and resource hopping. Alternatively, if a cell ID is given to each DL CC, the proposed embodiments may be applied to configure the resetting of UL scrambling codes related to the cell ID, a cyclic shift, the selection of a base sequence, and the selection of a hopping pattern.

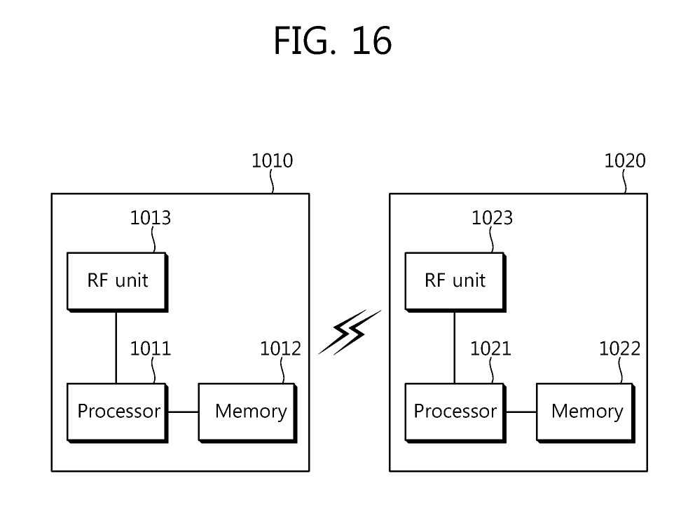

FIG. 16 is a block diagram showing wireless apparatuses in which the embodiments of present invention are implemented.

A UE 1010 includes a processor 1011, memory 1012, and a Radio Frequency (RF) Unit 1013. The processor 1011 supports multiple carriers and implements the operations of the UE in the embodiments of FIGS. 7 to 15. The processor 1011 processes an SRS on the basis of an SRS configuration received through a DL CC. The memory 1012 stores an SRS configuration for each UL CC. The RF unit 1013 transmits the SRS.

The DL CC through which the SRS configuration is received may be at least one of a plurality of DL CCs assigned to the UE, or the SRS configuration may be received through a plurality of DL CC assigned to the UE.

The SRS configuration may include an SRS configuration for a plurality of UL CCs. The SRS configuration may include an identifier or index to identify the plurality of UL CCs.

The SRS configuration includes cell-specific SRS configuration information and UE-specific SRS configuration information. The cell-specific SRS configuration information includes at least one of ‘srs-BandwidthConfiguration’, ‘srs-SubframeConfiguration’, and ‘ackNackSRS-SimultaneousTransmission’. The UE-specific SRS configuration information includes at least one of ‘srs-Bandwidth’, ‘srs-HoppingBandwidth’, ‘frequencyDomainPosition’, ‘Duration’, ‘srs-ConfigurationIndex’, ‘transmissionComb’, and ‘cyclicShift’.

A DL CC and a UL CC are linked together. A BS may inform UE of DL-UL linkage information through system information and/or higher layer signaling. An SRS may be transmitted through a UL CC (a first UL CC) linked to the DL CC in which the SRS configuration (a first SRS configuration) is received. Furthermore, a second SRS may be transmitted through a UL CC (a second UL CC) not linked to the DL CC.

A second SRS configuration for the second SRS may be predefined or may be obtained on the basis of a first SRS configuration. The second SRS configuration may be obtained from the first SRS configuration by applying an offset to the second SRA configuration. The offset may be predefined, included in the first SRS configuration, or given through an additional message.

A BS 1020 includes a processor 1021, memory 1022, and an RF unit 1023. The processor 1021 supports multiple carriers and implements the operations of the BS in the embodiments of FIGS. 7 to 15. The processor 1021 determines an SRS configuration for an SRS and informs UE of the SRS configuration through a DL CC. Furthermore, the BS performs UL scheduling on the basis of a received SRS. The memory 1022 stores an SRS configuration for each UL CC. The RF unit 1013 transmits the SRS configuration and receives the SRS.

The BS 1020 may transmit a cell-specific RRC message through which cell-specific SRS configuration information is transmitted through all the DL CCs. Cell-specific SRS configuration information transmitting in each DL CC may be identical irrespective of a CC or may be different for every CC.

If a DL/UL linkage within a cell is 1:n (i.e., UL heavy), the BS 1020 may transmit a cell-specific SRS configuration for a plurality of UL CCs through one DL CC. The cell-specific SRS configuration may include an identifier or an indicator for identifying the UL CCs.

The BS 1020 may transmit UE-specific SRS configuration information through each DL CC.

The BS 1020 may transmit the UE-specific SRS configuration information through a DL CC linked to a relevant UL CC.

The UE-specific SRS configuration information transmitted through the DL CC may include an indicator to indicate a UL CC to which an SRS configuration is applied.

The cell-specific SRS configuration of a UL CC linked to one DL CC may be transmitted according to the same method as the existing method, and the cell-specific SRS configuration of the remaining UL CCs may be included in UE-specific SRS configuration information. Alternatively, a cell-specific SRS configuration transmitting through one DL CC may be applied to all the UL CCs.

The cell-specific SRS configuration of the remaining UL CCs other than a UL CC linked to a DL CC through which cell-specific configuration information is transmitted may be predefined.

Cell-specific SRS configuration information transmitted through a DL CC may be used in a cell-specific SRS configuration for a linked UL CC, and an offset may be additionally transmitted for the cell-specific SRS configuration of the remaining UL CCs. The offset may be included in the cell-specific SRS configuration information or may be transmitted through an additional message. The offset may include a time offset, a frequency offset, a cyclic shift pattern, etc. Alternatively, a cell-specific SRS configuration may be predefined on the basis of information (e.g., a UL CC index or a cell ID) specific to the remaining UL CCs.

The UE-specific SRS configuration of a UL CC linked to one DL CC may be transmitted according to the same method as the existing method, and the UE-specific SRS configuration of the remaining UL CCs may be included in UE-specific SRS configuration information. Alternatively, a UE-specific SRS configuration transmitted through one DL CC may be applied to all the UL CCs.

The UE-specific SRS configuration of the remaining UL CCs other than a UL CC linked to a DL CC through which UE-specific configuration information is transmitted may be predefined.

The processor may include Application-Specific Integrated Circuits (ASICs), other chipsets, logic circuits, and/or data processors. When the above-described embodiment is implemented in software, the above-described scheme may be implemented using a module (process or function) which performs the above function.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

The above-described embodiments include various aspects of examples. Although all possible combinations for describing the various aspects may not be described, those skilled in the art may appreciate that other combinations are possible. Accordingly, the present invention should be construed to include all other replacements, modifications, and changes which fall within the scope of the claims.

1-20. (canceled)

21. A method of transmitting a sounding reference signal (SRS) in a wireless communication system, performed by a user equipment, the method comprising:
receiving a plurality of SRS configurations from a base station;
receiving downlink control information on a physical downlink control channel (PDCCH) from the base station, the downlink control information including an uplink resource assignment, a carrier indicator and an index, the carrier indicator indicating an uplink component carrier, the index indicating one of the plurality of SRS configurations; and
transmitting a SRS by using the indicated SRS configuration through the uplink component carrier to the base station.

22. The method of claim 21, wherein the plurality of SRS configurations are received via a Radio Resource Control (RRC) message.

23. The method of claim 22, wherein each of the plurality of SRS configurations includes information regarding a cyclic shift for SRS and a bandwidth for SRS transmission.

24. The method of claim 23, wherein the SRS is transmitted in a last Orthogonal Frequency Division Multiplexing (OFDM) symbol of a subframe comprising a plurality of OFDM symbols.

25. The method of claim 24, wherein a cyclic redundancy check (CRC) of the downlink control information is masked with the user equipment's identifier.

26. A user equipment of transmitting a sounding reference signal (SRS) in a wireless communication system, comprising:
a radio frequency unit configured to transmit and receive radio signals; and
a processor operatively coupled with the radio frequency unit and configured to:
receive a plurality of SRS configurations from a base station;
receive downlink control information on a physical downlink control channel (PDCCH) from the base station, the downlink control information including an uplink resource assignment, a carrier indicator and an index, the carrier indicator indicating an uplink component carrier, the index indicating one of the plurality of SRS configurations; and
transmit a SRS by using the indicated SRS configuration through the uplink component carrier to the base station.

27. The user equipment of claim 26, wherein the plurality of SRS configurations are received via a Radio Resource Control (RRC) message.

28. The user equipment of claim 27, wherein each of the plurality of SRS configurations includes information regarding a cyclic shift for SRS and a bandwidth for SRS transmission.

29. The user equipment of claim 28, wherein the SRS is transmitted in a last Orthogonal Frequency Division Multiplexing (OFDM) symbol of a subframe comprising a plurality of OFDM symbols.

30. The user equipment of claim 29, wherein a cyclic redundancy check (CRC) of the downlink control information is masked with the user equipment's identifier.
